(19) United States
(12) Patent Application Publication
(10) Pub. No.: US 2013/0047935 A1
(43) Pub. Date: Feb. 28, 2013

(54) Changeable pet collar with matching leash

(71) Applicant: Brenda L. Pieper, Monks Corner, SC (US)

(72) Inventor: Brenda L. Pieper, Monks Corner, SC (US)

(73) Assignee: Cabbage Patch, LLC

(21) Appl. No.: 13/137,516

(22) Filed: Aug. 23, 2011

(51) Int. Cl. A01K 27/00; A01K 29/00

(52) U.S. Cl. 119/792; 119/174; 119/858

(57) ABSTRACT

A pet collar and leash having interchangeable decorative facings constructed of a base member that is generally elongate in shape having removable facings with various decorative designs applied thereto. The base member and facings are removably mounted together by a hook and loop attachment so that the user can mix and match a combination of facings that are then attached to the base member to achieve matching or different appearances.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to pet accessories, namely articles to be worn by animals and is specifically directed to a pet collar and leash with interchangeable decorative facings.

### BACKGROUND OF THE INVENTION

In this present world where the latest celebrity picture, Facebook, and email photographs of persons and their pets is available for everyone's Internet viewing pleasure within hours of the images having been taken, trends and interests can come and go within a matter of weeks, if not sooner. This is particularly true with regard to accessories and pet apparel, as last week's “cutting edge” is often this week's “mainstream” and can just as easily become the following week's “hand me downs”. The popularity of matching apparel for pets so that the same add attractiveness to the pet and/or the pet's owner have become fashionable. Many owners of cats and dogs show their pets by dressing them up with decorative articles such as collars and leashes. Pets, like golf clubs, seem to be immune from the economic time or monetary hardships and a large industry has arisen to provide pet foods, pet toys and pet accessories for owners anxious to present their pets in the most favorable light. Animal collars chosen for attractiveness and ornamentation are well known in the field of pet care. However, these collars rapidly soil and deteriorate to lose their attractiveness.

A number of patents have been directed toward changeable apparel including dog collars.

U.S. Pat. No. 4,266,511 issued May 12, 1981 discloses an ornamental collar for an animal having a strip of protective and decorative fabric for extension along the exterior of an animal collar, the fabric being provided on its inner side with collar receiving loops and on its ends with buckle engaging ties.

Human changeable costumes are known and such examples are disclosed in U.S. Pat. No. 7,201,629 issued Apr. 10, 2007. This patent discloses a base foundation garment upon which may be fastened various interchangeable covers.

U.S. Pat. No. 5,865,148 issued Feb. 2, 1999 discloses a decorative dog collar together with snap fasteners to form a decorative collar. It is noted that when connection rings are used that the intermediate sections can be connected to the end sections by hook and fabric fasteners.

Decorative animal collars and leashes having decorative components adhesively attached to a flexible band and anchored by lengths of thread are disclosed in U.S. Pat. No. 7,350,342 issued Apr. 1, 2008.

What is needed are pet accessories that can be easily modified to suit the moment and easily cleaned. The present invention has a simple, functional base and various interchangeable facings to adapt the collar and/or leash as required. The facings are multiple in selection and are easily interchangeable with additional facings becoming available according to the fashions of the day. Consequently, the user can change the appearance of the pet appropriately for any situation simply by replacing the facing of the base collar and base leash with the most appropriate, most fashionable design.

### SUMMARY OF THE INVENTION

The present invention is a fashion pet collar and pet leash with interchangeable facings which is adapted for highly attractive and aesthetically appealing designs. The collar and leash include a basic flexible band made from a simple base material made from any appropriate material, such as leather or fabric and a facing of fabric or other material. Attachment means, for example hook and loop-type fasteners or hook and pile-type material commonly known as Velcro® are then used to affix various decorative facings to the collar base member and/or the leash base member to thereby modify the appearance of same as desired by the user. Additional attachment mechanisms may also be used for mounting the facings to the collar and/or leash base member such as temporary contact adhesion, magnets, and electrostatic means. With particular regard to the use of hook and loop-type fasteners, either the hook or loop portion of the fastening system is affixed to the respective pet base member by sewing the same to the base member and the complimentary loop or hook material is affixed to the various different decorative fabric facings by sewing same to one side of the fabric facing. After selecting the particular facing pattern or color desired, the user simply presses the facing into position onto the pet collar and/or leash base member, as appropriate for the attachment used. Thereafter the wearer is ready to face the world with a pet in the color or design of his or her choosing.

The pet collar and/or a leash may be used as dictated by the fashion of the day or serve as an accessory to, for example, as a color coordinate with the user's attire. The user may alternatively choose a contrasting color, material or glitter, or select facings with different patterns that allow multiple pet “outfits” for every day of the week.

While the facings are linear shaped similar to the base collar and/or the lead of the leash, the invention also contemplates facings having any number of shapes. Because the facings do not provide structural integrity to the garment, they can be shaped to cover all or a portion of the base member. The facings can be formed in fanciful designs, for example, various geometric shapes or silhouettes covering all or just a portion of the flexible base member.

The facings are designed to also be combined in a mix and match fashion wherein a plurality of smaller facings is provided. The user simply attaches multiple facings to the collar and/or leash, thereby creating unique designs or patterns from the combination of the facings.

The owner may buy for his or her pet, for example, colored facings, or facings with various designs, such as plaid, abstract, paisley, or designs having a glitter component, such as beads, crystals, metallic or cubic zirconium, or designs showing an affiliation to particular colleges, universities, sports teams, or activities.

It is an object of this invention to provide an easily adaptable, multi-use, changeable appearance pet collars and pet leashes.

It is another object of this invention to provide a pet collar with easily replaceable facings.

It is still another object of this invention to provide a pet leash with easily replaceable facings.

It is yet another object of this invention to provide replaceable facings to pet collars and leashes that allows the user to easily clean the individual facings.

It is a further object of this invention to provide an item of pet apparel that allows the user to adapt his or her pet to the current fashion.

The invention will be better understood and objects other than those set forth above will become apparent when consideration is given to the following detailed description thereof. Such description makes reference to the annexed drawings.

### BRIEF DESCRIPTION OF THE DRAWINGS

FIG. 1 is a perspective view of the inventive leash with the midsection removed;

FIG. 2 is a perspective view of the leash of FIG. 1 showing the end portions of the facing separated and turned over;

FIG. 3 is a perspective view of the inventive leash shown in FIG. 1 with a different decorative facing;

FIG. 4 is a top plan view of the inventive collar with the midsection removed;

FIG. 5 is a perspective view of the collar of FIG. 4 showing the end portions of the facing separated and turned over; and

FIG. 6 is a top plan view of the collar of FIG. 4 with a different decorative facing.

### DETAILED DESCRIPTION OF THE INVENTION

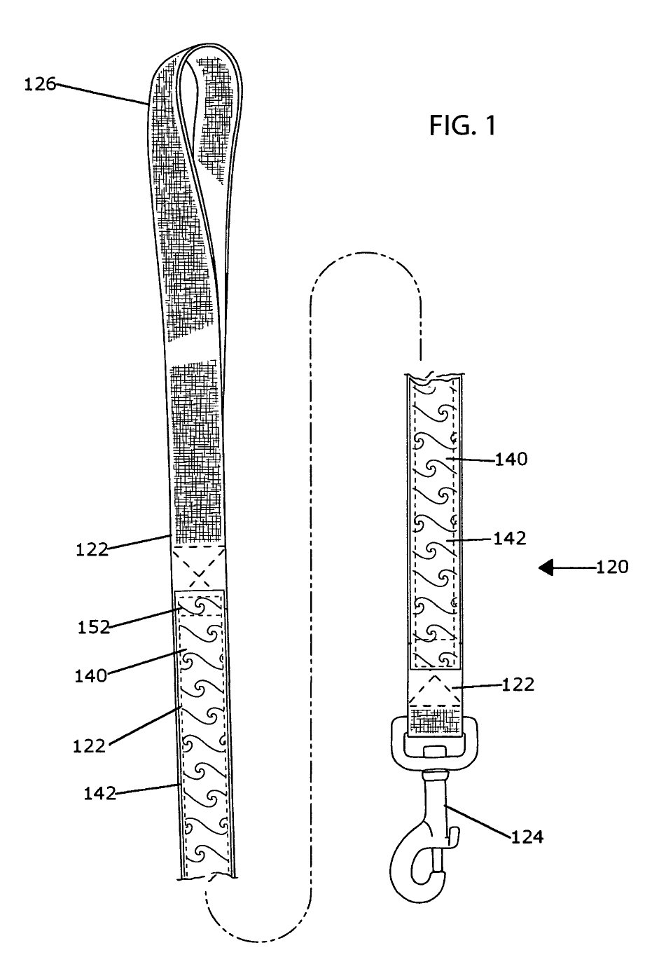

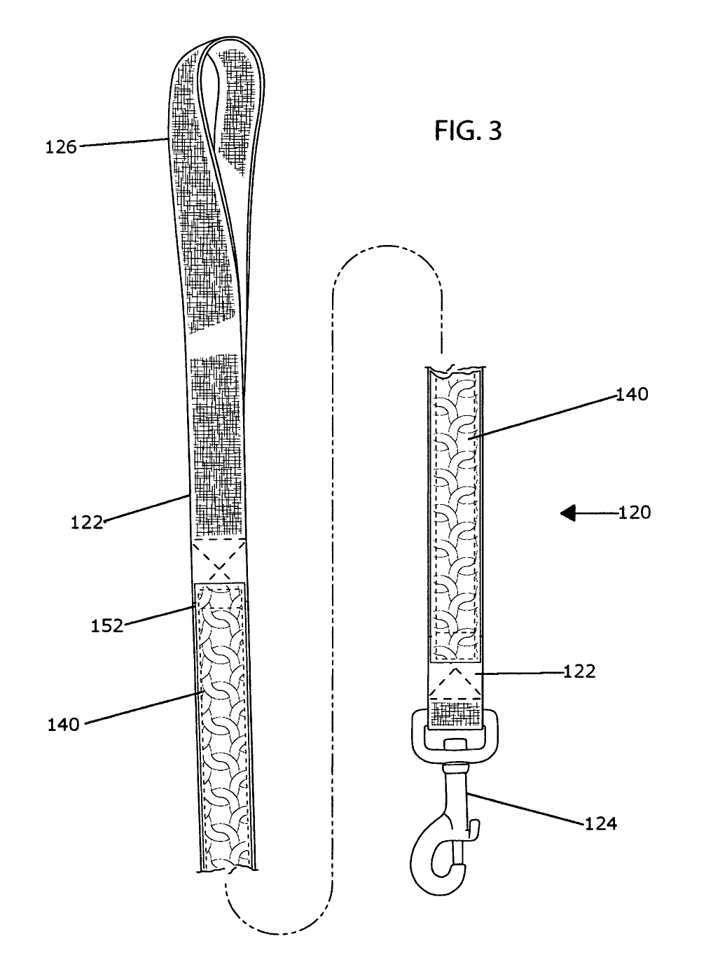

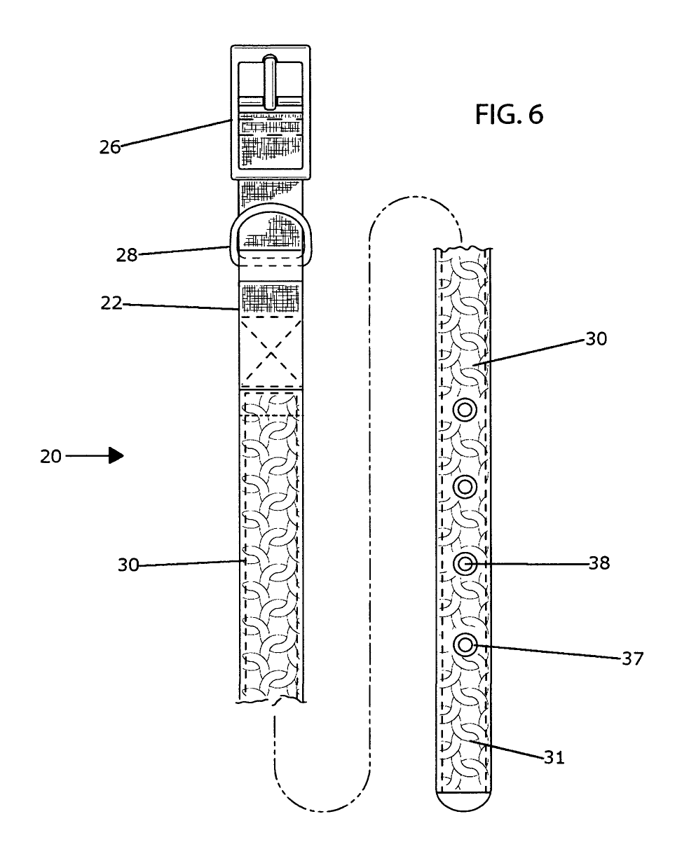

The preferred embodiments and best modes of the changeable pet collar and leash invention are shown in FIGS. 1 through 6. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

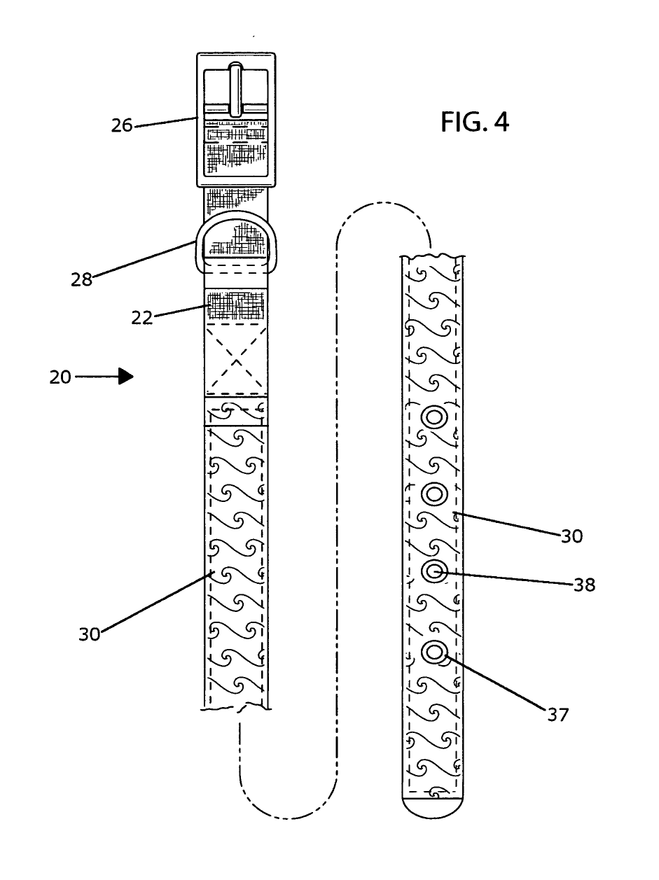

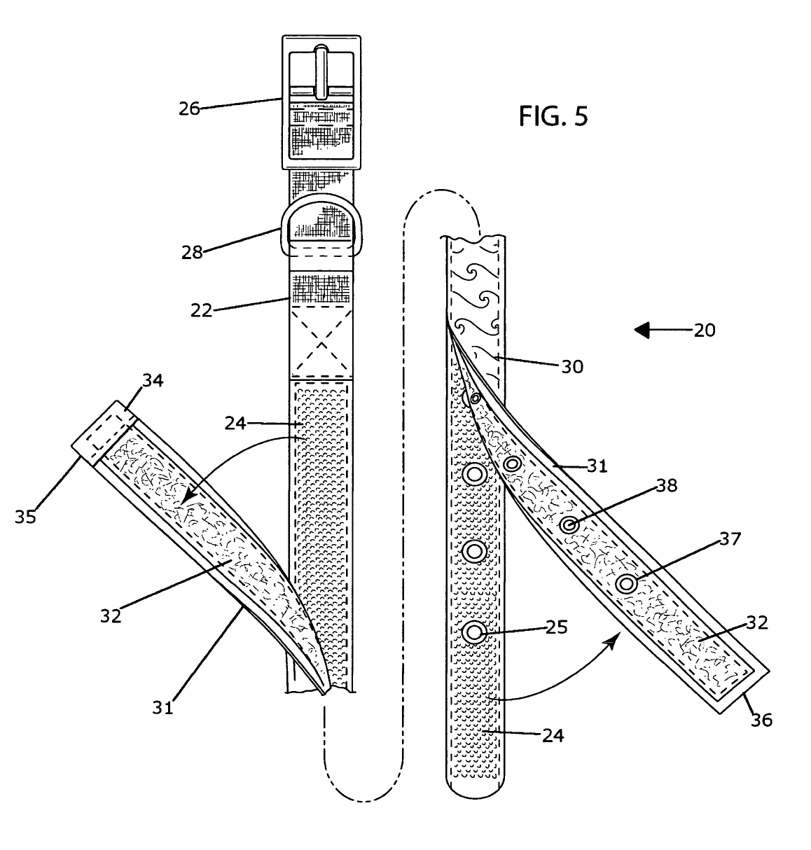

The pet collar 20 as shown in FIGS. 4 through 6 includes a flexible band 22 forming a base layer preferably constructed of a simple ply of woven fabric such as nylon having a width of ¾ inches with a hook and loop layer 24 sewn on to base layer 22. The flexible band 22 has a series of aligned belt holes 25 formed in a first end section which may have a metal eyelet and a belt buckle 26 and a leash clip loop 28 mounted at an opposite second end. A decorative facing 30 to be used with collar 20 preferably has a fabric layer 31 with pile or a hook and loop layer 32 sewn onto the facing layer 31. At least one end 34 of the decorative facing 30 is folded over the pile or hook and loop layer 32 and sewn on itself thus providing a tab structure 35 which allows the decorative facing 30 to be easily attached and removed from band 22. The distal end of pile layer 32 is spaced from the end of the fabric 31 to provide an end tab 36. The pet collar facing 30 may be constructed from any material appropriate for the manufacture of apparel, including but not limited to cotton, linen, silk, wool, leather, polyester, nylon, rayon, man-made fibers, or combinations thereof with an optional glitter component secured thereto. As shown in FIG. 5, the pet collar facing 30 has a plurality of metal eyelets 37 surrounding a plurality of holes 38 are sized and are spaced so that they can be aligned with belt holes 25 allowing easy insertion of the tongue of the belt buckle 26. The flexible band 22 has a long linear dimension generally suitable for being placed circumferentially the neck of an animal. Buckle 26 and eyelets 25 are mounted at each respective end of the band member 22 to facilitate joining of the ends into a circular configuration which will fit around the neck of the animal. Those skilled in the art will understand that the band ends may also be fastened together using a variety of connector mechanisms which includes magnets, snaps and the like. It is understood that other belt buckling mechanisms are well-known and are encompassed by this description, including but not limited to traditional ring and prong style closures, D-rings, cam buckles, snap closures, and the like.

The decorative interchangeable facing 30 is shaped in substantially the same shape as the flexible band member 22 to cover the outside surface of the flexible band member 22. The facing 30 includes an interior pile or hook and loop layer 32 sewn on exterior fabric layer 31 with aesthetically pleasing designs applied thereto. Alternatively, the exterior layer 31 may be a solid color, differing colors, different designs such as plaid, paisley, checkered or abstract or include various simulated or semi-precious stones, beads, crystal, ornamental metal, plastic, or ceramic formations; and various appliqués applied in an artistically pleasing pattern. It is also envisioned that designs showing various college, university or sports teams can be used by mounting same to the facing.

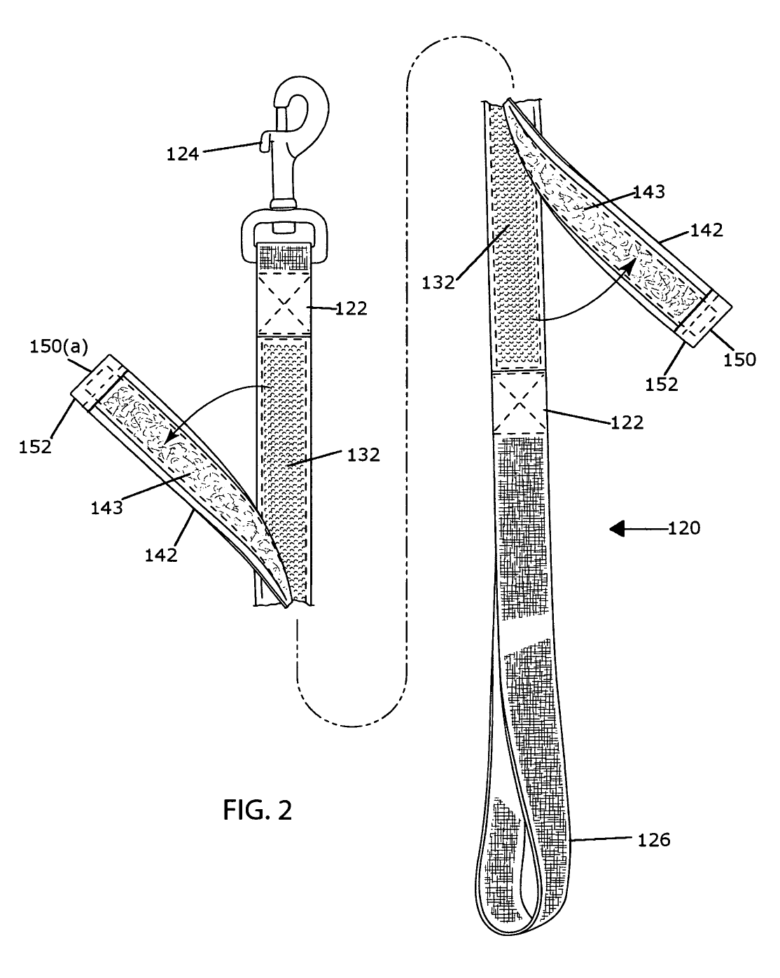

The pet leash 120 is shown in FIGS. 1 through 3. The pet leash 120 lead member 122 may be constructed in accordance with the present invention from any material appropriate for use in restraining a pet, including but not limited to leather, polyester, nylon, rayon, man-made fibers, or combinations thereof. The pet leash 120 includes a flexible belt-like base member or lead member 122 having an elongated shape preferably about 1 inch in width and about 4 to about 6 feet in length with exterior hook and loop layer 132 and interior single ply woven fabric, leather or plastic lead 122 as shown in FIG. 2. The lead member 122 has a standard leash clip 124 on one end which can snap onto a collar loop 28 and a leash grip 126 on the opposing end in the form of a loop.

A decorative interchangeable facing 140 is provided shaped in substantially the same shape as the lead member 122 to cover the outer or exterior surface of the lead member 122. The facing 140 includes an interior surface layer of pile or hook and loop construction 143 and exterior surface layer 142 of fabric or synthetic material with aesthetically pleasing designs applied thereto. The inner layer 143 is preferably sewn to the exterior layer 142. Each end 150, 150(a) of the decorative facing 140 is folded over and sewn on itself, thus providing a tab structure 152 which allows the decorative facing 140 to be easily attached and removed from lead member 122. Alternatively, the exterior surface layer 142 may be a solid color, differing colors, different designs such as plaid, paisley, checkered or abstract or include various simulated or semi-precious stones, beads, crystal, ornamental metal, plastic, or ceramic formations; and various appliqués applied in an artistically pleasing pattern. It is also envisioned that designs showing applications to various college, universities, sports teams or advertisers can be used.

The interior layer 143 of the facing 140 is a material is a pile or hook and loop closure, for example Velcro®, and is mounted to the exterior or outer layer 132 of the lead member 122 with the looped material covering a significant area of the surface area of the lead member 122. Complimentary hook and loop or pile material 143 is mounted to inner or interior surface of the facing 140 allowing the facing 140 and lead member 122 to be securely attached to one another by pressing the interior surface 143 of the facing 140 to the exterior layer surface 132 of the lead member 122. Another attachment means can be magnetic strips fastened to the lead and facing which hold the two leash components together.

In use, the pet owner will generally have on hand a number of different facings 40 and 140, such that she or he may choose from a wide selection of “looks” to suit the specific pet or her or his mood. In addition to varying designs, colors or materials, glitter type materials such as beads, crystals, metallic member and cubic zirconium can be added to the facings 40 and 140. Additional facings 30 and 140 may also be purchased with the latest designs or motifs applied thereto. The user simply mates the facing 30 or 140 to the respective base member 22 or lead member 122 which is already on hand, and the entire apparatus may be used with the pet.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. Decorative animal article comprising:
an elongate flexible base member in the form of a belt having an interior and an exterior surface;
a removable unisize decorative facing having an interior and exterior surface;
said base member having an attachment means mounted on said exterior surface;
said decorative facing having an attachment means complimentary to said base member attachment means mounted on said interior surface;
said interior surface of said decorative facing being removably mateable to said exterior surface of said base member; and,
fastener means mounted to at least one end of said base member.

2. Decorative animal article as claimed in claim 1 wherein said decorative facing is of a colored material and includes a design.

3. Decorative animal article as claimed in claim 1 wherein said attachment means for said base member and said decorative facing is of a hook and loop type.

4. Decorative animal article as claimed in claim 1 wherein said base member and said decorative facing are manufactured of materials chosen from the group consisting of cotton, linen, silk, wool, leather, polyester, nylon, rayon, man-made fibers, and combinations thereof.

5. Decorative animal article as claimed in claim 1 wherein said attachment means is chosen from the group consisting of temporary contact adhesion, magnets and electrostatic attraction.

6. A pet leash comprising:
a flexible leash lead, a leash clip mounted to a first end of said leash lead, a leash grip formed at a second end of said leash lead;
said leash lead having a base layer and a hook and loop attachment layer mounted on an exterior surface of said base layer;
a removable decorative facing having an interior and exterior surface;
said decorative facing having a complimentary hook and loop attachment means to that of said lease lead mounted on said interior surface; and
said interior surface of said decorative facing being removably mateable to said exterior surface of said belt base member.

7. A pet leash as claimed in claim 6 wherein said decorative facing is colored and has a design thereon.

8. A pet leash as claimed in claim 6 wherein each end of said decorative facing is folded back and sewn on itself forming a tab section.

9. A pet leash as claimed in claim 6 wherein said decorative facing has a plurality of light reflecting pieces mounted thereto, said light reflecting pieces being taken from a group consisting of beads, metallic members, crystals and cubic zirconium.

10. A pet leash as claimed in claim 6 wherein said leash and said decorative facing is manufactured of materials chosen from the group consisting of cotton, linen, silk, wool, leather, polyester, nylon, rayon, man-made fibers, and combinations thereof.

11. A pet collar comprising:
a flexible band having a series of aligned attachment holes formed at first end of said flexible band and a buckle mounted at an opposite end of said flexible band,
said flexible band having hook and loop closure means mounted to an exterior surface;
a unisize colored decorative facing, having an interior and exterior surface;
said decorative facing having a complimentary hook and loop closure means to that of said flexible band mounted on said interior surface allowing said facing to be removably mounted on said flexible band, said decorative facing defining a plurality of aligned holes which correspond in size and spacing to the flexible band attachment holes;
said interior surface of said decorative facing being mateable to said exterior surface of said flexible band; and
end attachment means mounted to said flexible band whereby the ends of said collar may be attached to one another.

12. A pet collar as claimed in claim 11 wherein said decorative facing is colored and has a design thereon.

13. A pet collar as claimed in claim 11 wherein said decorative facing is a plurality of different material pieces.

14. A pet collar as claimed in claim 11 wherein said decorative facing has a plurality of light reflecting pieces mounted thereto, said light reflecting pieces being taken from a group consisting of beads, metallic members, crystals and cubic zirconium.

15. A pet collar as claimed in claim 11 wherein said flexible band and said decorative facing are manufactured of materials chosen from the group consisting of cotton, linen, silk, wool, leather, polyester, nylon, rayon, man-made fibers, and combinations thereof.

16. A pet leash as claimed in claim 11 wherein each end of said decorative facing is folded back and sewn on itself forming a tab section.

17. A decorative matching pet leash and collar comprising:
said leash comprising a flexible leash lead, a leash clip mounted to a first end of said leash lead and a leash grip mounted at a second end of said leash lead;
said flexible leash lead having a strip of hook and loop closure material mounted thereon;
a unisize linear decorative facing, having an interior and exterior surface;
at least one end of said decorative facing being folded back and sewn on itself providing a tab section;
said decorative facing having a complimentary hook and loop closure means mounted on said interior surface allowing said facing to be removably mounted on said flexible band;
said collar comprising a flexible linear band having a series of aligned holes at first end of said flexible band, a buckle mounted at an opposite end of said flexible band, said flexible band having hook and loop closure means mounted on an exterior surface;
a linear decorative facing, having an interior and exterior surface and defining a plurality of aligned holes which correspond in size and spacing to said flexible band aligned holes;
said decorative facing having a complimentary hook and loop closure means mounted on said interior surface allowing said facing to be removably mounted on said flexible band;
at least one end of said decorative facing being folded back and sewn on itself providing a tab section;
said interior surface of said decorative facing being mateable to said exterior surface of said flexible band; and
end attachment means mounted on at least one end of said collar.

18. A pet leash as claimed in claim 16 wherein said decorative facing has a design thereon.

19. A pet leash as claimed in claim 16 wherein said collar and said leash decorative facings have a plurality of light reflecting pieces mounted thereto, said light reflecting pieces being taken from a group consisting of beads, metallic members, crystals and cubic zirconium.

20. A pet leash as claimed in claim 16 wherein said collars and said leash decorative facing is manufactured of materials chosen from the group consisting of cotton, linen, silk, wool, leather, polyester, nylon, rayon, man-made fibers, and combinations thereof.
